(19) United States
(12) Patent Application Publication
(10) Pub. No.: US 2026/0008082 A1
(43) Pub. Date: Jan. 8, 2026

(54) DUAL BLAST AIR CANNON APPARATUS AND METHOD FOR CLEANING DEPOSITS IN AN INDUSTRIAL PROCESS VESSEL

(71) Applicant: Dracyon Corp, Jacksonville, AL (US)

(72) Inventor: Jefferson Landers Shelton, Jacksonville, AL (US)

(73) Assignee: Dracyon Corp, Jacksonville, AL (US)

(21) Appl. No.: 19/258,884

(22) Filed: Jul. 2, 2025

Related U.S. Application Data
(60) Provisional application No. 63/667,084, filed on Jul. 2, 2024.

(51) Int. Cl. B08B 5/02

(52) U.S. Cl. CPC B08B 5/02

(57) ABSTRACT

A dual blast air cannon apparatus and method for cleaning particulate deposits in an industrial process. The dual blast air cannon includes an air cannon having a compressed air reservoir and an air cannon valve for selectively releasing the air cannon. A discharge end of the air cannon is coupled with a proximal end of an elongate pipe. A distal end of the elongate pipe includes one or more butterfly valves, with a selected one of the one or more butterfly valves defining a second contained volume between the selected one of the butterfly valves and the air cannon valve. A discharge nozzle injects one or more selectable air pressure blasts through a process wall to release accumulated deposits within the industrial process vessel.

### CROSS-REFERENCE TO RELATED APPLICATION

This application claims the benefit of priority of U.S. provisional application No. 63/667,084, filed Jul. 2, 2024, the contents of which are herein incorporated by reference.

### BACKGROUND OF THE INVENTION

The present invention relates to air cannons, and more particularly to air cannons for removing deposits in industrial process vessels, such as coal fired furnaces, and the like.

Air cannon installations in many Industrial applications are common. The conventional air cannon OEM recommended installation is located as close to the discharge nozzle as possible. The justification for this placement is that it reduces the pressure drop which can be experienced during discharge of the cannon. Air cannon OEMs also push for small air tanks to facilitate greater numbers of air cannon for cleaning the industrial process.

Because most air cannons in Industrial applications are located proximal to the discharge nozzle, the air cannon will often experience failures because the air cannon are not protected from the harsh temperatures and the accumulation of particulate deposits of their operating environments.

As can be seen, there is a need for an improved air cannon installations for blast cleaning in industrial processes.

### BRIEF DESCRIPTION OF THE DRAWINGS

FIG. 1 is a side elevation view illustrating an air cannon installation according to aspects of the invention.

FIG. 2 is a diagram illustrating an air cannon installation for illustrating levels of operation.

FIG. 3 is a diagram illustrating operational specifications and performance parameters for an air cannon system.

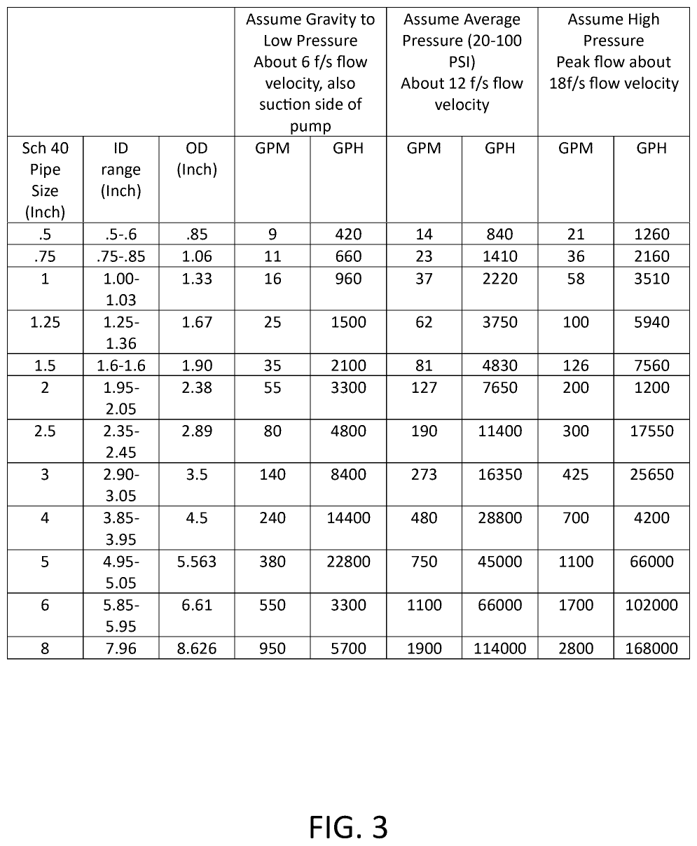

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provide an improved air cannon installation for blast cleaning of particulate deposits in industrial process environments. Aspects of the present invention contemplate that the air cannon be deployed further from the process to protect the air cannon from the harsh temperatures and deposits of the industrial process. In this regard, the air cannon installations of the present invention are deployed contrary to conventional wisdom in the industry.

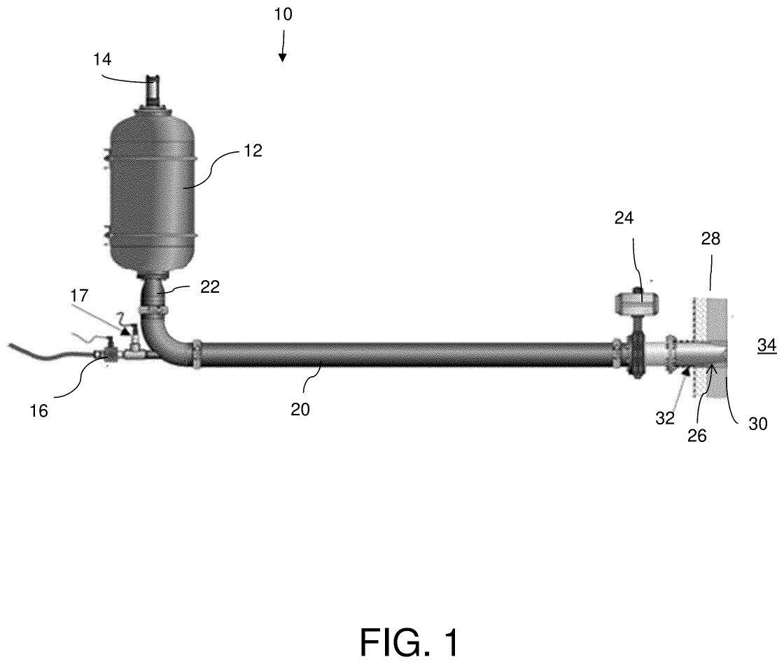

A representative air cannon installation is shown in reference to FIG. 1. The air cannon system includes an air cannon 10, having a reservoir 12 or canister with a predetermined volume. The air cannon reservoir 12 is coupled with a source of pressurized air (not shown) via a conduit 14 that is selectively operable via to charge the air cannon reservoir 12 to a predetermined pressure, which may be measured by a pressure transducer. In the embodiment shown in FIG. 1, an air cannon valve contained within the reservoir is selectively operable to release the pressurized air from the reservoir 12 through the outlet 22.

An extended length of a steel pipe 20 communicatively couples the outlet 22 of the air cannon reservoir 12 with a discharge port 26 defined through a process wall 28 containing the industrial process. A butterfly valve 24 is interposed between a distal end of the extended length of the steel pipe 20 and an inlet of a discharge nozzle 32 carried through the discharge port 26 in process wall 28 and refractory lining 30.

In the representative embodiment shown in FIG. 1, the air cannon reservoir 12 is a 4″ air cannon having a 300 Liter reservoir capacity. The extended length of the steel pipe 20 is a schedule 40 pipe having a 6″ diameter and a length of 10 ft, defining a second volume of pressurized fluid of about 61.2 Liter volume. The outlet 22 adapts the 4″ reservoir outlet to the 6″ diameter pipe 20. The butterfly valve 24 is preferably a 6″ valve with a pneumatic drive. The discharge nozzle 32 is preferably a 6″ monster nozzle, manufactured by Integrated Global Services, Richmond, Virginia.

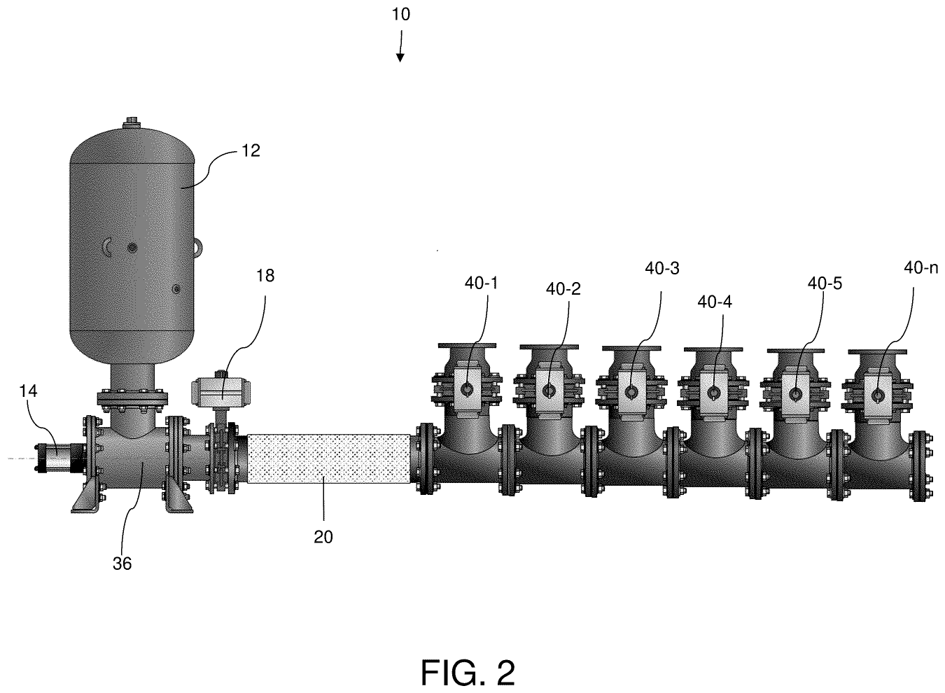

In the air cannon system 10 pressure drop and volume are key parameters for producing a desired cleaning discharge. In the air cannon system of the invention, the butterfly valve 24 is utilized in cooperation with the air cannon valve (18 in the external air cannon valve of FIG. 2). Many in the industry believe that butterfly valves are not good air cannon valves because of their opening speed. This perceived deficiency is overcome by increasing the size of the butterfly valve 24, for example from the 4″ reservoir outlet to 6″ pipe 20, which will flow over twice the air as a smaller 4″ opening valve. The butterfly valve 24 also protects the air cannon valve 18 from the harsh environment of the industrial process. This protection extends the reliability of the air cannon system 10, which can also be linked to improved cleaning. If the air cannon 10 is not working then it is not cleaning.

The air cannon system 10 also contemplates that the operation of the butterfly valve 24 in cooperation with the air cannon valve 18 are controlled at a desired temporal spacing so as to provide a “double fire” air cannon system that can supercharge the air cannon performance. Typically, the temporal spacing is between about 0.1 second and 0.2 seconds.

How does this work? In a typical 70 L reservoir 12 of conventional air cannon systems, the blast has less pressure drop because of its location. Air stored in the air cannon reservoir 12 represents cleaning energy. This cannon effectiveness is limited by the cleaning energy.

The 300 L system moves much more particulate material because of the increased cleaning energy. This system has a reduced initial force (peak force) because of the pressure drop. The system with its two 90s and the longer pipe run must have a pressure drop.

Science tells us that when moving the source of energy (contained volume of pressurized air) further away, a pressure drop will result. For example, if nozzle 32 is discharged into the industrial process vessel 34 is 10′ away with a 6″ pipe 20, the volume held in this length of pipe 20 is 80 L. With a 70 liter air cannon reservoir 12, this is a significant pressure drop, that is, before the air exits the discharge nozzle 26 it must fill up the enclosed volumetric space of the elongated pipe 20. Effectively, the pressurized air goes from a storge area of 70 L to that of 150 L (70+80). But by utilizing a 300 L reservoir 12 in the present system 10, then while it's a pressure drop it not as significant.

Because the harsh environments within the industrial process vessel 34, it is desirable for industrial plants to move the air cannon 10 further from the process vessel 34 to protect the air cannons 10. Most air cannons 10 in Industrial application fail because they are not protected from the environment. In short, it doesn't matter how powerful your air cannon is if it's not working due to damage from the operating environment. The dual blast air cannon system 10 of the present invention is designed to reduce this pressure drop suffered due to the remote location of the air cannon.

In the illustration of FIG. 1, the butterfly valve 24 is mounted at a distal end of the steel pipe 20, proximal to the discharge nozzle 32. The steel pipe 20 between the butterfly valve 24 and the internal air cannon valve, define a second volume of a pressurized fluid, and are charged with a pressurized air source via the fill solenoid valve 16. This will reduce the pressure drop. In the dual blast configuration, the butterfly valve 24 is opened to start the firing sequence. The butterfly valve 24 opens slower than the air cannon valve. The air cannon valve is then fired after a predetermined temporal period, preferably before all the air from the second volume of pressurized fluid is discharged. More preferably, the air cannon valve is fired such that the first volume of pressurized fluid is discharged at the nozzle 26 corresponding with a peak of the discharge of the second pressurized fluid source.

The result is a first force that strikes the buildup from the initial opening of the butterfly valve 24. This force is great enough to move material, but this force is increased by the air cannon blast from the subsequent operation of the air cannon valve 18. This allows greater cleaning to be performed. The initial blast will clean material, but force is lost when transferred to the material. The higher force following by release of the air cannon valve 18, and the initial collision point has moved which allows greater cleaning.

As indicated, butterfly valves are generally not considered to perform as well as air cannon valves because they open slowly. In the dual blast air cannon system 10, the diameter of the elongate steel pipe 20 and the butterfly valve 24 are increased from 4″ to 6″ to allow a greater amount of air to pass through the system thus not impacting air blast performance because of the opening speed of the butterfly valve 24. For comparison, a 4″ pipe has a flow of 240 gpm verses 550 gpm for a 6″ pipe.

In the dual blast air cannon system 10, cleaning is concerned with controlling the airflow, the greater the flow, the better the cleaning. The dual blast air cannon system 10 provides the following advantages:
Greater cleaning energy (air volume) at a higher pressure. The higher pressure increases the flow rate, which improves cleaning performance;
The function of an air cannon is to move material. It only makes sense that you can move more material with more cleaning energy (Air Volume represents the cleaning energy);
The dual blast air cannon system 10 is designed to move material and increase efficiency. This system does both.

The dual blast air cannon system 10 may also be configured as an adjustable force cleaning system. This allows the operator to dial in the force needed to move the material based on an accumulation of deposits that need to be moved. Based on the same air pressure, the dual blast air cannon system may be operated at three different cleaning levels, selected to correspond with a level of deposit accumulation to be cleaned within the industrial process vessel 34. The levels may be understood in reference to the alternative embodiment of the dual blast air cannon system 10, shown in FIG. 2.

As seen in FIG. 2, one or more tee protector valves 40-1-40-n are coupled with a distal end of the elongate pipe 20. In this instance, the one or more tee protector valves 40-1-40-n, in combination with the elongate pipe 20 define a second pressurized air storage volume, between the tee 36 and air cannon valve 18 and a selected tee protector valve 40-1-40-n. Each tee protector valve 40-1-40-n, is coupled with a corresponding nozzle 32-n extending through a corresponding discharge port 26-n defined in the vessel wall 28.

In the example of FIG. 2, the elongate pipe 20 and the one or more tee protector valves 40-1-40-n, may define a second contained volume of 160 Liters. The air cannon reservoir 12 contains a first contained volume of pressurized air. In this example, the air cannon air tank is an 8″ Big Blue Air Cannon 12 with an 300 liter volume. The system shown in FIG. 2 has three levels of operation, as explained in the following.

### Level 1

This system while being the weakest is still stronger than competitive systems. In Level 1, air cannon valve 18 and a selected tee protector valve 40-1-40-n are both closed. This allows air to collect within the pipe 20 and tee. This pipe 20 and an 8″ tee act as an air tank defining the second contained volume that allows 160 L of pressurized air to collect. Please note this is over double the volume as per competitive systems and represents more cleaning energy which equals more cleaning potential.

To discharge this system at Level 1, simply activating (opening) the selected tee protector valve 40-1-40-n allows the second contained volume of the system 10 to discharge through the corresponding nozzle 32-n. This system 10 may discharge from a 6″ nozzle coupled with a selected one of the one or more tee protector valves 40-1-40-n and is injected into the industrial process vessel 34. As will be appreciated from the present disclosure, the greater the diameter the nozzle 32-n, the greater the air flow. The more the air flow, the better the cleaning.

This system 10 will also suffer from a pressure drop. This system should suffer from a 10% pressure drop but if a 100 psi air supply is provided then this means the pressure at discharge is 90 psi. peak force for a 6″ pipe. (10% pressure drop) at 90 psi equals a peak force of 2,543 lbs. Likewise, peak force from a 4″ pipe at 100 psi equals 1,256 lbs. The peak force including the pressure drop is 1.9 times greater. Or as a salesman would say—double the cleaning power with 2.3 time more cleaning energy. Greater cleaning force and volume equal greater cleaning area.

### Level 2

To operate the dual discharge air cannon system at Level 2, opening a selected tee protector valve 40-1-40-n and the air cannon valve 18 and discharge the 8″ air cannon. This applies 300 L of air to the material deposits. This is almost double the cleaning energy used in Level 1. This system will also have a pressure drop which is greater than the pressure drops experienced in the firing of Level 1. This system should fill the 160 L void of the second contained volume before discharging from the corresponding nozzle 32-n.

The inventor estimates that the pressure drop will be 30%. Air flow is greater because it's a 8″ pipe 20, which after the selected tee protector valve 40-1-40-n, is reduced to 6″ for discharge at the corresponding nozzle 32-n. Newton Laws tells us that energy can be converted from one form (pressure) to another form without the loss of energy. With a 30% pressure drop, the 100-psi firing pressure becomes 70 psi. This represents a peak force from a 6″ pipe of 1,978 lbs., which has 1.57 times higher cleaning force than a 4″ pipe at 100 psi. The cleaning energy is 4.28 times greater. This represents greater cleaning due to the greater volume and force.

Level 3 is by far the highest cleaning force and energy. This level is the combination of the two contained volumes of the air cannon system 10 blasting together. The fact that the dead zone 8′ pipe and multiple tee valves 40 are already filled, this reduces the pressure drop from the 8″ cannon 12. The inventor estimates the pressure drop on this system will be 15%. This means the system from a 6″ nozzle will fire at a peak force of 2,402 lbs. or 1.9 times greater peak force than a 4″ pipe at 100 psi, but has 6.57 more cleaning energy.

Representative operational parameters of the Dual Blast Air Cannon System are shown in the following table 1.

TABLE 1

| | Air | | | air | |
|---|---|---|---|---|---|
| | Cannon | | | (liters) | air |
| | Tank | | Operational | used | (liters) |
| | size | # of | cycle | per | used |
| | Liters | discharges | (minutes) | hour | per day |
| Martin | 70 | 12 | 20 | 16800 | 403200 |
| Dracyon | 160 | 6 | 60 | 960 | 23040 |
| Level 1 | | | | | |
| Dracyon | 300 | 6 | 120 | 900 | 21600 |
| Level 2 | | | | | |
| Dracyon | 460 | 6 | 240 | 690 | 16560 |
| Level 3 | | | | | |
| Total air | | Total air | | | |
| usage (liters) | | usage (liters) | | | |
| per hour | | per day | | | |
| Total air | 16800 | 403200 | | | |
| usage (liters) | | | | | |
| per day | | | | | |
| Total air | 2550 | 61200 | | | |
| usage (liters) | | | | | |
| per day | | | | | |

Why does the Dual Blast Air Cannon System clean better? The reasons are as follows:

Greater force at nozzle discharge. The forces above are based on the pipe 20 diameter but not the nozzle 32. The 6″ Monster Nozzle generates (per CFD studies by third party) generate 4 time more force. The Martin Smart Nozzle is designed to clean a short wide area and decreases velocity. The main two reasons the dual blast air cannon system 10 can replace two Martin Smart Nozzles is the fact that the system increases velocity (nozzle) and has greater volume.

While we would love to maintain its peak force but it's not. Please consider what happens when this instantaneous force hits the buildup, an opposite and equal reaction occurs. When the force from the compressed air is greater than the force holding the material in place then the energy is transferred, and the deposit material is blasted away. The issue with that as the material flies away so does the energy. To clean a larger area this power must continue to flow. This additional power comes from increased volume. Standard air cannons are limited in their cleaning not because of the force but because of the nozzle design and volume.

A recommended sequence to clean the vast area difference notice the firing sequence. Every hour place the initial 160 L air blast which is immediately followed by a 300 L bast. This dual blast is followed by an every 2 hour blast of the combined blast which has a great deal greater cleaning area. These hourly and every other hour blast cycles can clean a much greater distance for the following reasons:
1) Increased cleaning energy; and
2) In the first blast (160 L) this cleans a certain area but is limited because of the transfer of energy. The fact that we have a longer blast (because of the volume) allows greater cleaning area. The second blast with 300 L cleans a greater area and changes the collusion point so that the big blast can clean up to 9 meters.

Other benefits include this system has redundant cleaning. Air cannon valve 18 acts as an air cannon while you have the air cylinder 8″ Big Blue Air Cannon. Please note that in air cannon, the number one reason for the equipment failing is the exposure to the harsh environment of the industrial process vessel. The air cannon valve 18 is protected from the environment by the one or more tee protector valves 40-1-40-n and the length of pipe 20. The second reason for failure is duty cycle. As seen in reference to Table 1, because of the greater cleaning force, the duty cycle is 3 times lower than a standard air cannon. If you assume 250,000 cycles life span the 70 liter air cannon will take.

It should be understood, of course, that the foregoing relates to exemplary embodiments of the invention and that modifications may be made without departing from the spirit and scope of the invention as set forth herein.

I claim:

1. An air cannon system for selectively discharging a source of pressurized fluid to clean deposits from an interior wall of an industrial process vessel, comprising:
an air cannon reservoir containing a first volume of a pressurized fluid configured to be charged from a pressurized fluid source;
an air cannon valve selectively operable to release the first volume of the pressurized fluid from the air cannon reservoir;
a nozzle extending through a discharge port defined through a wall of the industrial process vessel;
a pipe in fluid communication with the air cannon valve and the nozzle; and
a butterfly valve, interposed between the nozzle and the air cannon valve, defining a second volume of a pressurized fluid configured to be charged from the pressurized fluid source, the butterfly valve configured to be selectively activated prior to an activation of the air cannon valve to discharge the second volume of the pressurized fluid through the nozzle.

2. The air cannon system of claim 1, wherein the butterfly valve is selectively activated by a predetermined temporal period prior to the activation of the air cannon valve.

3. The air cannon system of claim 2, wherein the predetermined temporal period corresponds with a length and a diameter of the pipe interconnecting the air cannon valve and the butterfly valve.

4. The air cannon system of claim 2, wherein the predetermined temporal period is between about 0.1 and 0.2 seconds.

5. The air cannon system of claim 1, further comprising:
a fill solenoid valve selectively operable to communicate the source of pressurized fluid to fill the second volume.

6. The air cannon system of claim 5, further comprising:
a pressure transducer adapted to monitor a pressure of the pressurized fluid within the second volume.

7. An air cannon system for selectively discharging a source of pressurized fluid to clean deposits from an interior wall of an industrial process vessel, comprising:
an air cannon reservoir configured to be charged from a pressurized fluid source to contain a first volume of a pressurized fluid;
an air cannon valve selectively operable to release the first volume of the pressurized fluid from the air cannon reservoir;
a nozzle extending through each of a plurality of discharge ports defined through a wall of the industrial process vessel;
a pipe having a proximal end coupled with the air cannon valve; and
a plurality of tee protector valves disposed in series at a distal end of the pipe, each of the tee protector valves selectively operable to communicate the first volume of the pressurized fluid with a corresponding nozzle in communication with a selected tee protector valve, wherein the selected tee protector valve, the pipe, and the air cannon valve define a second volume of a pressurized fluid configured to be charged from the pressurized fluid source, the selected tee protector valve configured to be selectively activated prior to an activation of the air cannon valve to discharge the second volume of the pressurized fluid through the corresponding nozzle.

8. The air cannon system of claim 7, wherein the selected tee protector valve is selectively activated by a predetermined temporal period prior to the activation of the air cannon valve.

9. The air cannon system of claim 8, wherein the predetermined temporal period corresponds with a length and a diameter of the pipe interconnecting the air cannon valve and the selected tee protector valve.

10. The air cannon system of claim 8, wherein the predetermined temporal period is between about 0.1 and 0.2 seconds.

11. The air cannon system of claim 7, further comprising:
a fill solenoid valve selectively operable to communicate the source of pressurized fluid to fill the second volume.

12. The air cannon system of claim 11, further comprising:
a pressure transducer adapted to monitor a pressure of the pressurized fluid within the second volume.

13. A method of cleaning deposits from an interior wall of an industrial process vessel, comprising:
charging an air cannon reservoir from a pressurized fluid source to contain a first volume of a pressurized fluid;
charging a pipe interconnecting an air cannon valve at the air cannon reservoir with a butterfly valve coupled with a nozzle extending through a discharge port of the industrial process vessel to contain a second volume of the pressurized fluid; and
selectively operating the butterfly valve prior to the air cannon valve to discharge the second volume of the pressurized fluid through the nozzle.

14. The method of claim 13, further comprising:
selectively operating the air cannon valve at a predetermined temporal period after operating the butterfly valve to discharge the first volume of the pressurized fluid through the nozzle.

15. The method of claim 14, wherein the predetermined temporal period corresponds with a length and a diameter of the pipe.

16. The method of claim 14, wherein the predetermined temporal period is between about 0.1 and 0.2 seconds.

17. The method of claim 14, wherein the predetermined temporal period corresponds with the discharge of the first volume of pressurized fluid through the nozzle at a peak flow of the second volume of pressurized fluid through the nozzle.

18. The method of claim 14, wherein the butterfly valve comprises a plurality of tee protector valves disposed in series at a distal end of the pipe, each of the tee protector valves selectively operable to communicate each of the first volume of the pressurized fluid and the second volume of the pressurized fluid with a corresponding nozzle in communication with a selected tee protector valve, wherein the selected tee protector valve, the pipe, and the air cannon valve define the second volume of the pressurized fluid, and
activating the selected tee protector valve prior to the activation of the air cannon valve to discharge the second volume of the pressurized fluid through the corresponding nozzle.

19. The method of claim 18, further comprising:
activating the air cannon valve to discharge the first volume of the pressurized fluid through the corresponding nozzle.

20. The method of claim 19, further comprising:
closing each of the air cannon valve and the selected tee protector valve.
